(19) United States
(12) Patent Application Publication
(10) Pub. No.: US 2012/0216142 A1
(43) Pub. Date: Aug. 23, 2012

(54) System and Method for Creating and Managing Lesson Plans

(75) Inventors: Aaron Bock, Dallas, TX (US); Daniel R. Martin, Santa Clara, CA (US); Joyce Ann S. Martin, Santa Clara, CA (US)

(73) Assignee: STEP AHEAD STUDIOS, Dallas, TX (US)

(21) Appl. No.: 13/362,156

(22) Filed: Jan. 31, 2012

Related U.S. Application Data
(60) Provisional application No. 61/445,305, filed on Feb. 22, 2011.

(51) Int. Cl. G06F 17/30; G06F 3/048

(52) U.S. Cl. 715/780; 707/825; 707/E17.005

(57) ABSTRACT

A system and method for creating and managing custom lesson plans. A computing device includes a lesson planning tool that receives a lesson creation request from a user. The lesson planning tool is responsive to the lesson creation request to create a customized lesson plan based on game data and rule data included in the lesson creation request. The lesson planning tool also creates and stores a customized lesson plan record in a database. The customized lesson plan record identifies the customized lesson plan and audience members that are eligible to access the customized lesson plan. The lesson planning is responsive to a lesson plan request from another user to determine whether the other user is eligible to access customized lessons plans stored in the database based on audience data included in the lesson plan request.

### BACKGROUND

Software applications have been developed for computer systems that enable educators to display educational lesson plans to an audience, such as one or more students. Such lesson plans may use games to teach or educate the audience about various subjects, such as foreign languages, spelling, mathematics, science, etc. These educational games often include animations and graphics that enable unique user-interactions with the lesson plan. As a result, such games can create memorable experiences for the user, which increases user interest and improves knowledge retention. When preparing such educational lesson plans, the author or designer of the lesson plan typically preselects content and/or games to include in a lesson plan that are expected to maximize the effectiveness of the lesson plan. Ultimately, the effectiveness of a particular lesson plan depends on how that particular lesson plan is received by the audience.

An instructor, such as teacher, experienced in developing lessons plans for a particular audience can usually gauge the effectiveness that a particular lesson plan has with different audiences and/or with different members of a particular audience. As a result, such instructors are more likely to be able to identify educational games that would maximize the effectiveness of a lesson plan for a given audience. Conventional lesson planning systems may enable a user to select predefined games to include a lesson plan. However, conventional lesson plan systems do not enable a user to designate multiple games and designate rules for controlling which of the designated games will be presented during the lesson plan.

### SUMMARY

According to one aspect, a system is provided for creating a lesson plan. The system includes at least one processor and at least one database. The at least one processor is encoded with a plurality of instructions. The processor executes the plurality of instructions to receive a lesson plan creation request. The lesson plan creation request includes a selection of at least two of an educational game from the game data, an educational subject, and a lesson rule. The processor also executes the plurality of instructions to create a custom lesson plan based on the selection of the at least two of the educational game from the game data, the educational subject, and the lesson rule. The processor also executes the plurality of instructions to store the custom lesson plan in the at least one database.

According to another aspect, a system is provided for creating a lesson plan. The system includes at least one processor and at least one database. The at least one processor is encoded with a plurality of instructions. The processor executes the plurality of instructions to receive a lesson plan creation request. The lesson plan creation request includes a selection of at least two of an educational game from the game data, an educational subject, and a lesson rule. The processor also executes the plurality of instructions to create a custom lesson plan based on the selection of the at least two of the educational game from the game data, the educational subject, and the lesson rule. The processor also executes the plurality of instructions to store the custom lesson plan in the at least one database. The processor also executes the plurality of instructions to receive a lesson plan request. The lesson plan request identifying a particular custom lesson plan. The processor also executes the plurality of instructions to retrieve the particular custom lesson plan from the database. The processor further executes the plurality of instructions to transmit the particular custom lesson plan for display.

According to another aspect, a method is provided for creating a lesson plan. The method includes generating at least one data entry form that includes lesson plan data for display. The lesson plan data includes game data, educational subject data; lesson rule data, and audience member data. The method also includes receiving a lesson plan creation request at a processor. The lesson plan creation request includes a selection of at least two of an educational game from the game data, an educational subject, and a lesson rule. The method also includes creating a custom lesson plan at the processor based on the selection of the at least two of the educational game from the game data, the educational subject, and the lesson rule. The method further includes storing the custom lesson plan in at least one database.

### BRIEF DESCRIPTION OF THE DRAWINGS

FIGS. 1A-1B are block diagrams of computing environments for creating lesson plans according to aspects of a lesson planning system.

FIG. 2A is a screen shot of an authentication form according to one aspect of the lesson planning system.

FIG. 2B is a screen shot of a lesson plan information form according to one aspect of the lesson planning system.

FIGS. 2C-2E are screen shots of an audience lesson plan management forms according to one aspect of the lesson planning system.

FIG. 2F is a screen shot of a game selection management form according to one aspect of the lesson planning system.

FIG. 2G is a screen shot of a subject data selection management form according to one aspect of the lesson planning system.

FIG. 2H is a screen shot of a combination game/subject data selection form according to one aspect of the lesson planning system.

FIG. 2I is a screen shot of a rules selection management form according to one aspect of the lesson planning system.

FIG. 2J is a screen shot of a lesson summary form according to one aspect of the lesson planning system.

FIGS. 2K and 2L are screen shots of a lesson plan edit forms according to one aspect of the lesson planning system.

FIG. 2M is a screen shot of an introduction page according to one aspect of the lesson planning system.

FIG. 2N is a screen shot of a report generated by the lesson planning tool according to one aspect of the lesson planning system.

FIG. 3 is a block diagram of a lesson planning tool according to one aspect of the lesson planning system.

FIG. 4 illustrates a method for creating lesson plans according to one aspect of the lesson planning system.

FIG. 5 illustrates a method for requesting a lesson plan according to one aspect of the lesson planning system.

### DETAILED DESCRIPTION

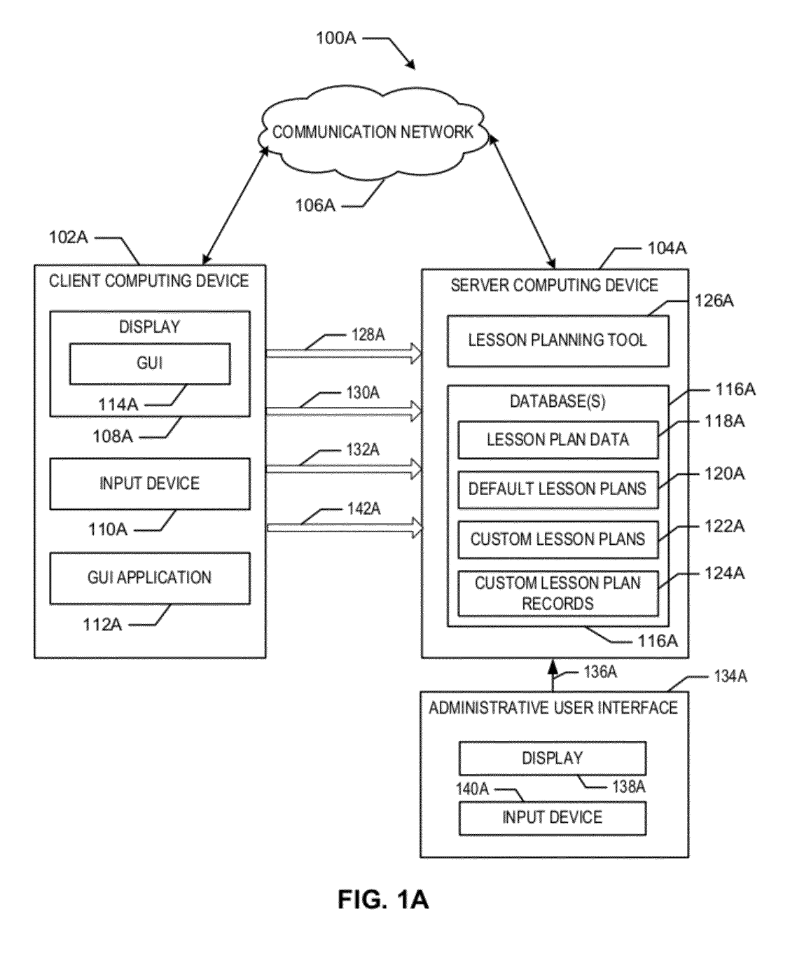

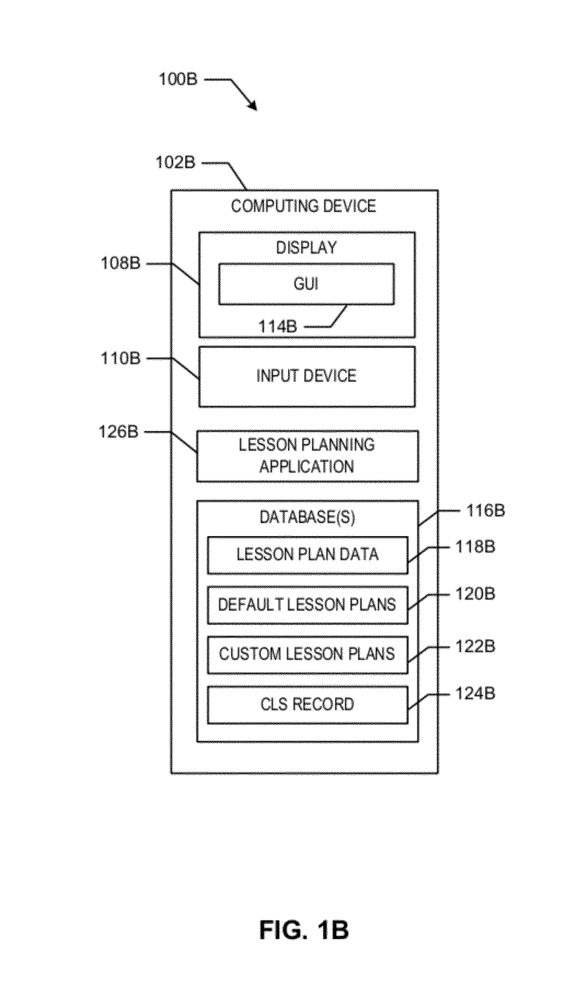

FIG. 1A is a block diagram of a lesson planning system 100A for creating and displaying lesson plans. The lesson planning system 100A includes a client computing device 102A, a server computing device 104A, and a communication network 106A to enable data communication between the client computing device (“client”) 102A and the server computing device (“server”) 104A. According to one aspect, the client 102A is a computing or processing device, such as a laptop computer, a personal digital assistant, a tablet computer or a standard personal computer. The communication network 106A can be the Internet, an intranet, or another communication network. In this example, the client 102A and the server 104A may communicate data between each other using Hypertext Transfer Protocol (HTTP), which is a protocol commonly used on the Internet to exchange information between client computers and servers. In another aspect, the client 102A and the server 104A may communicate data among themselves via a wireless communication signal, using a Wireless Application Protocol (WAP) which is a protocol commonly used to provide Internet service to digital mobile phones and other wireless devices.

According to one aspect, the client 102A includes a display 108A, such as a computer monitor, for displaying lesson plan data and/or input forms. The client 102A may also include an input device 110A, such as a keyboard or a pointing device (e.g., a mouse, trackball, pen, or touch screen) to enter lesson plan data into one or more input forms. The client 102A also includes a graphical user interface (or GUI) application 112A, such as a browser application. The graphical user interface application 112A generates a graphical user interface 114A on the display 108A that enables a user of the client 102A to view and/or interact with lesson plan data and/or lessons plans retrieved from the server 104A.

Lesson plans are created, for example, by administrative users for the purpose of teaching or educating one or more audience members about a particular subject or topic. As used herein, audience members refer to, for example, students, apprentices, trainees, or any other group interested in learning. A particular lesson plan may include content, such as textual information, graphical illustrations, games, and/or minigames related to a particular topic or subject. As an example, the administrative users may be instructors of a foreign language class and the audience members may be students in that foreign language class. Other examples exist.

The server 104A includes one or more databases (“database”) 116A that store lesson plan data 118A. Lesson plan data 118A includes, for example, game data, subject data, rule data, and audience member data.

Game data includes various educational games that are arranged or categorized into various games sets and one or more corresponding minigames. For example, a category of game sets may be human body parts and a corresponding minigame may be entitled “Pancake Face.” In this example, the minigame Pancake Face may involve enabling a user to indentify and/or spelling words that correspond to facial features (e.g., nose, eyes, mouth, etc.) appearing on the face of a Pancake.

Subject data includes educational subject data that can be taught within a given minigame. For example, subject data may include lexical information, such as words and/or phrases, mathematical information, science information, and/or language information. Other example exists.

Rule data includes various lesson rules that determine what game or combination of games to present to a user during presentation of the lesson plan. For example, rules may include a rule to present lowest word accuracy minigames during the lesson, a rule to present highest word accuracy minigames, a rule to present the newest games, a rule to present the longest unplayed or infrequently played games, a rule to present most frequently played games, and a rule to present random games. As another example, the rules may include a rule to present particular games based on time data and/or date data. For example, a rule may specify that only minigames added to lesson data within the past 30 days are to be included in a particular lesson. As known to those skilled in the art, game data may include metadata that specifies a date and/or time that a particular minigame was added as lesson data. Other examples of lesson rules exists,

Audience member data may include name data, contact data, and area of study (e.g., foreign language, mathematics, etc) for each audience member assigned to a lesson plan. For example, if the audience members for a lesson plan are students, the name data may include the name of each student, the contact data may include a telephone number, e-mail address, or a mailing address for each student, and the area of study or training data may include the title of a class. Audience member data may also include authentication data that includes, for example, valid usernames and/or passwords for audience members.

The database 116A also includes one or more default lesson plans 120A and one or more customized lesson plans 122A. Default lessons plans 120A are lesson plans that are predefined by the product designers and associated with a particular topic or subject. Customized lesson plans 122A are unique lesson plans that are defined by one or more administrators for one or more particular audience members. As known to those skilled in the art, a database includes records that may have one or more data fields. In this example, the database 116A includes a plurality of customized lesson plan records 124A and each particular customized lesson plan record 124A identifies at least one audience member associated with that particular customized lesson plan 122A. As a result, a particular customized lesson plan may be associated with one or more audience member's names.

Although FIG. 1A illustrates the database 116A as being located on the server 104A, it is contemplated that the database 116A can be located remotely from the server 104A in other aspects. For example, the database 116A may be located on a database server (not shown) that is communicatively connected to the server 104A.

The server 104A executes a lesson planning tool 126A to retrieve lesson plan data 118A and/or lesson plans 120A, 122A from the database 116A for transmission to the client 102A. The lesson planning tool 126A includes instructions, applets, and/or modules for retrieving and displaying content, including animated content, programs, games, and other content (e.g., lesson plans). According to one aspect, the lesson planning tool 126A is an executable file, such as a small web format (SWF) file. According to another aspect, the lesson planning tool 126A is an application, such as a software application, executed by a processor of the server 104A.

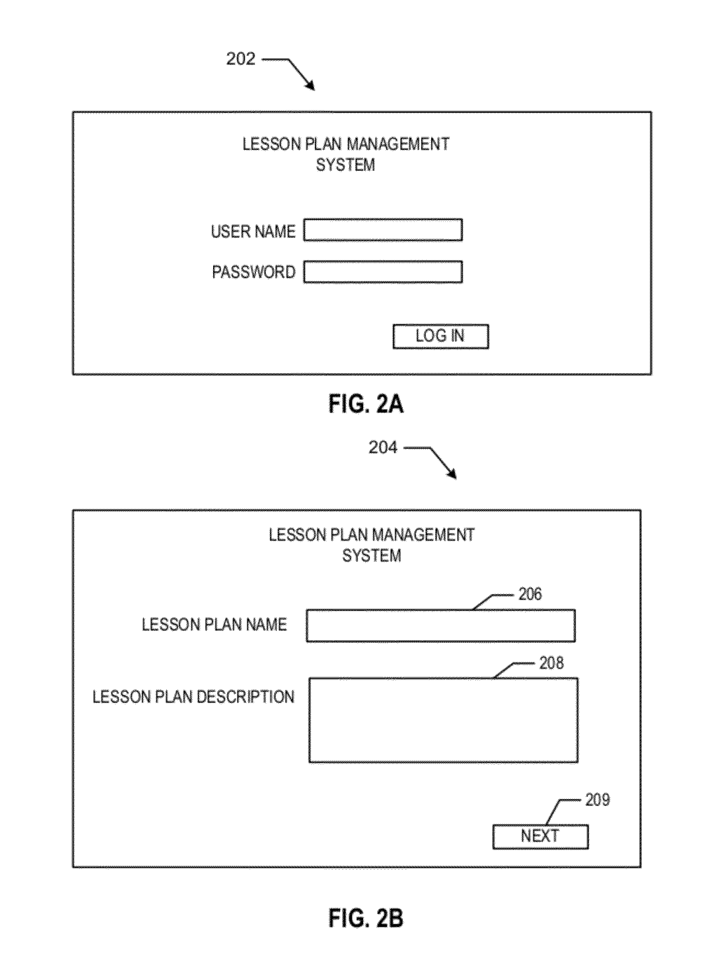

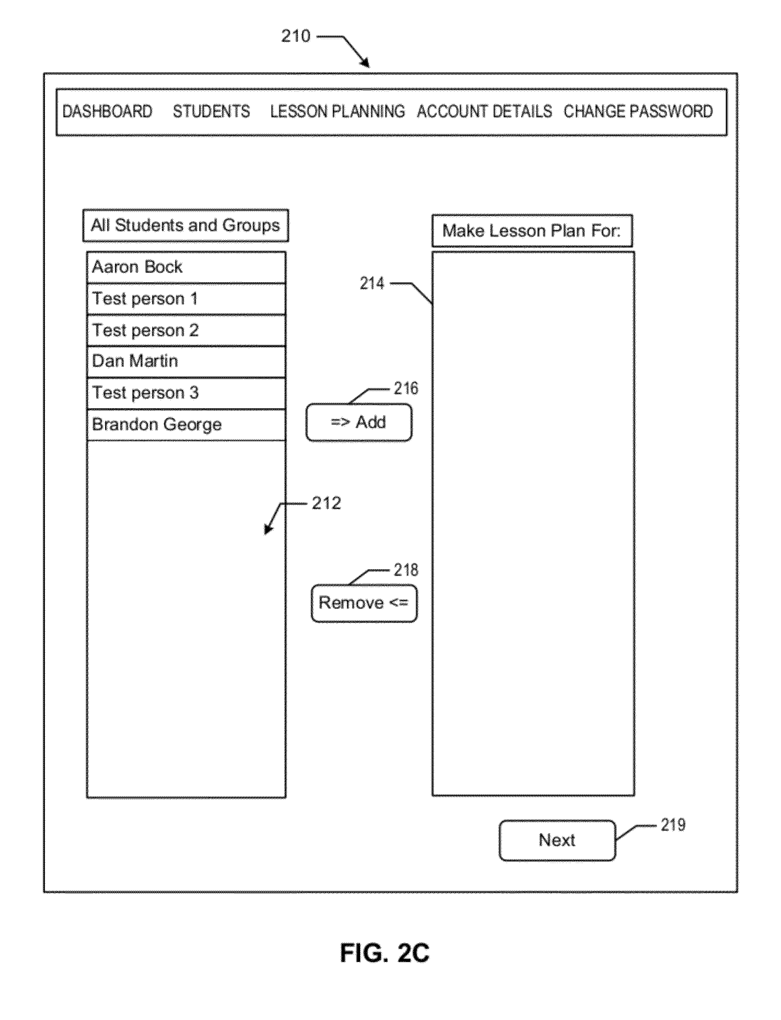

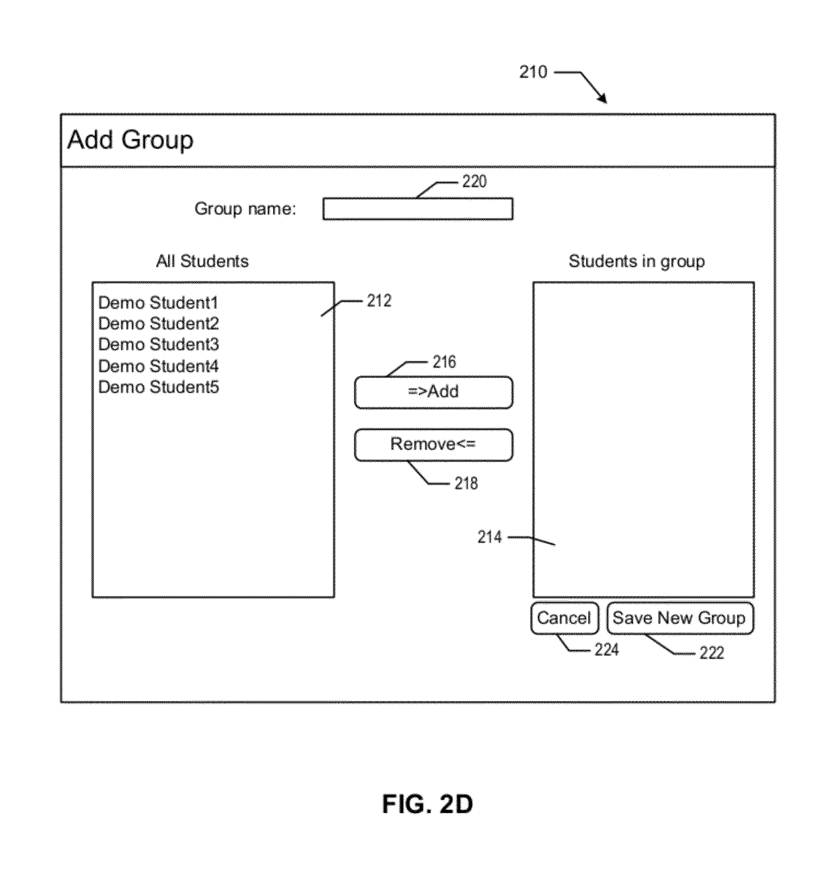

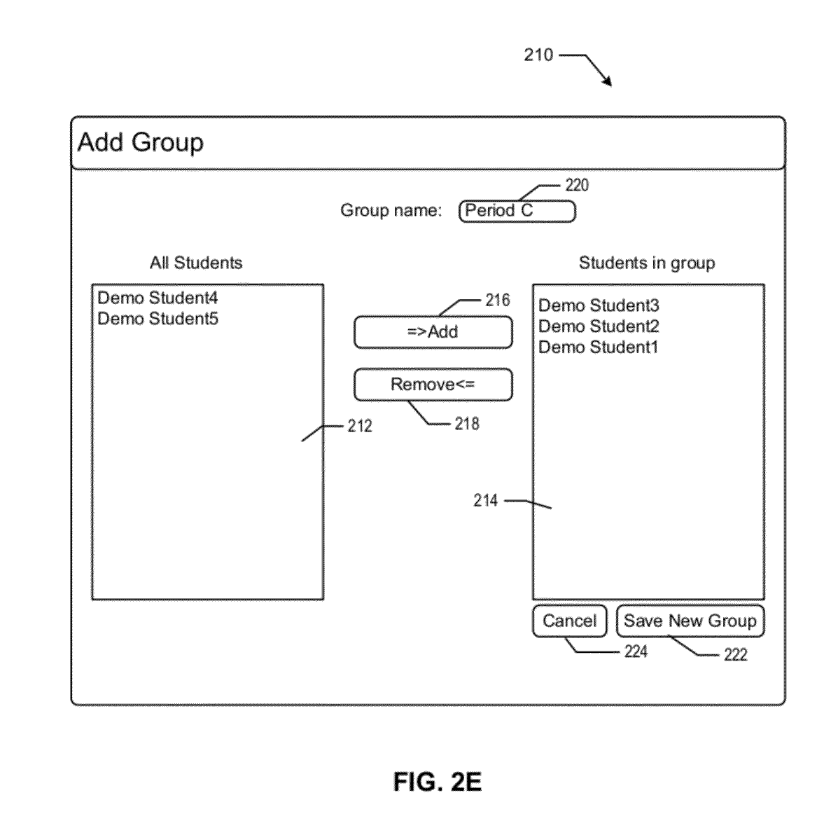

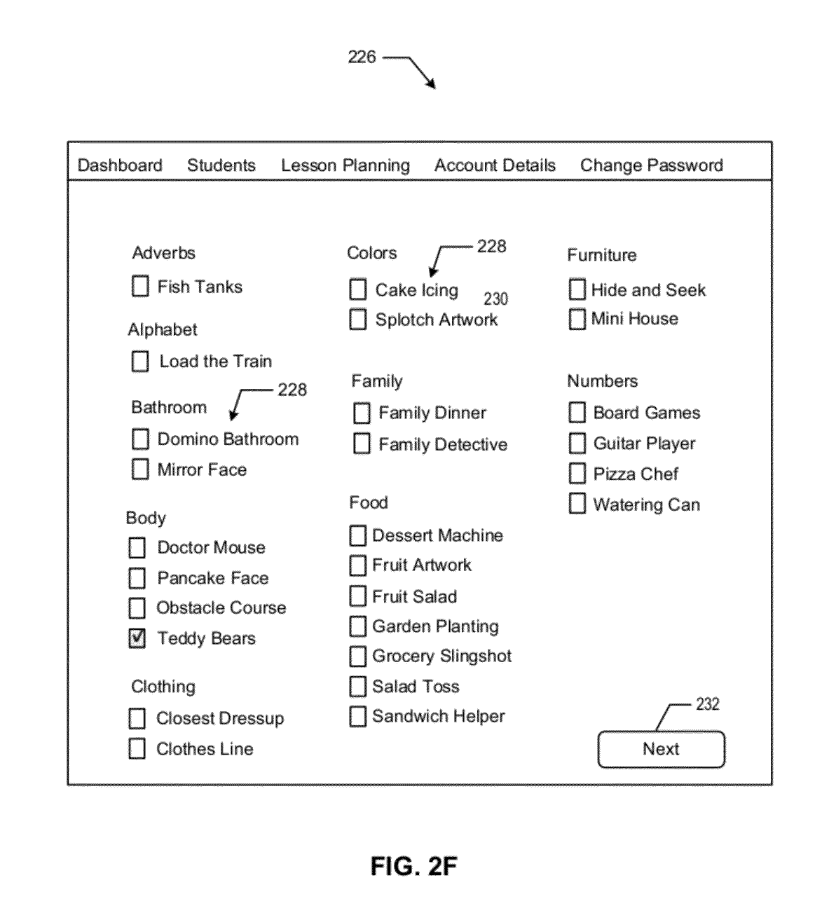

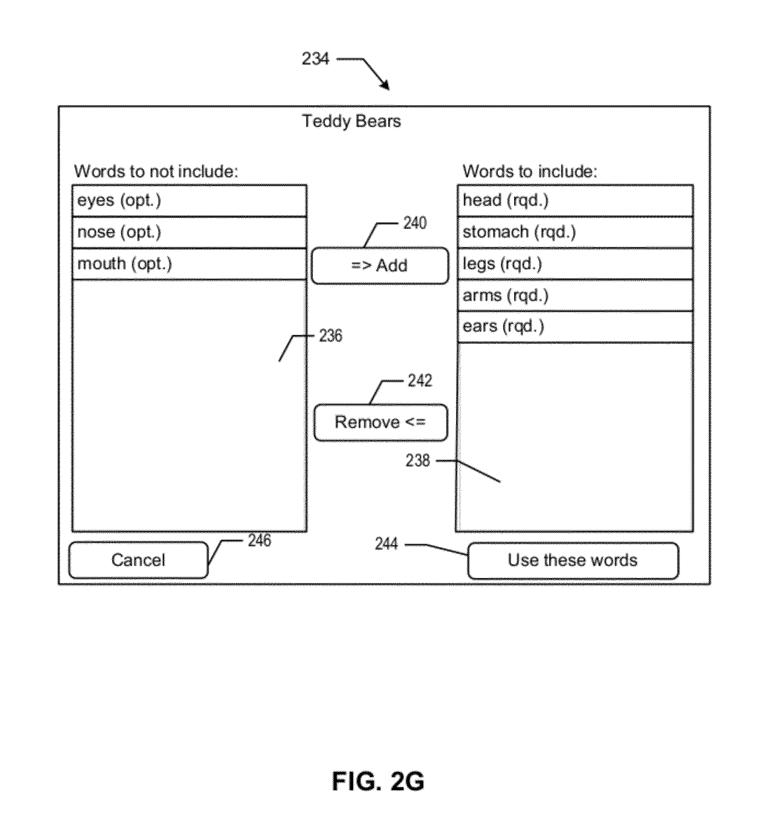

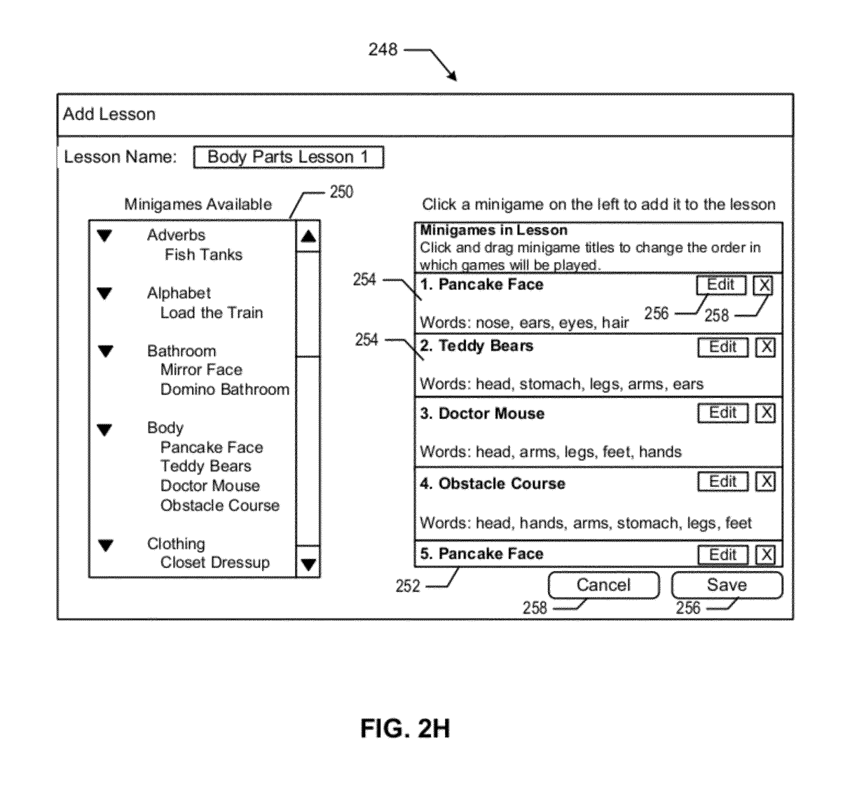

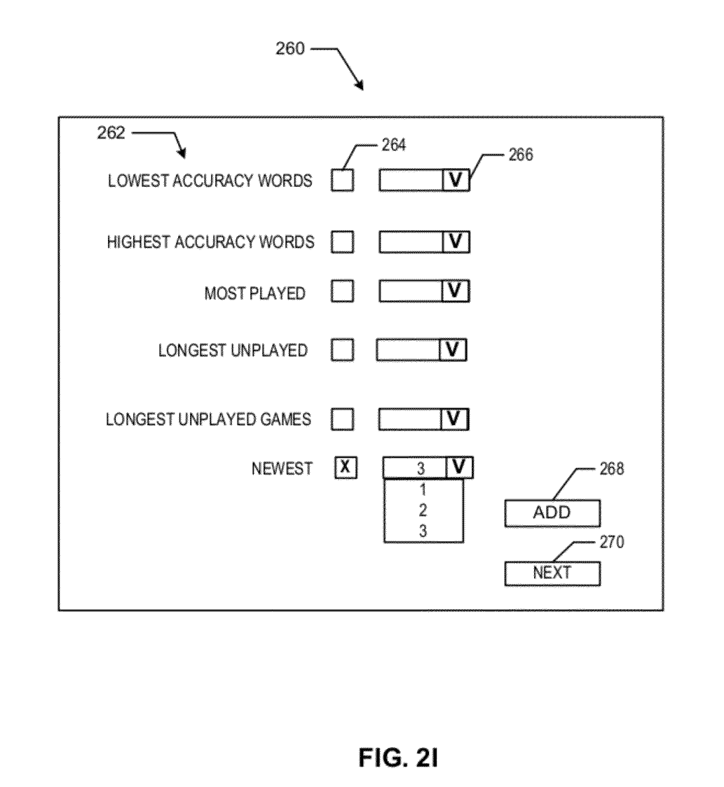

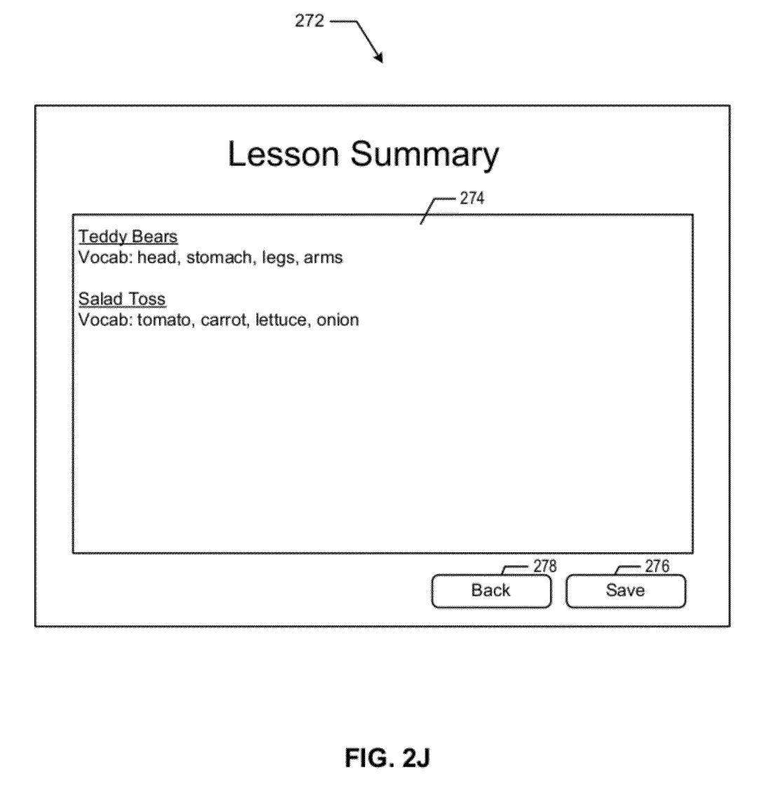

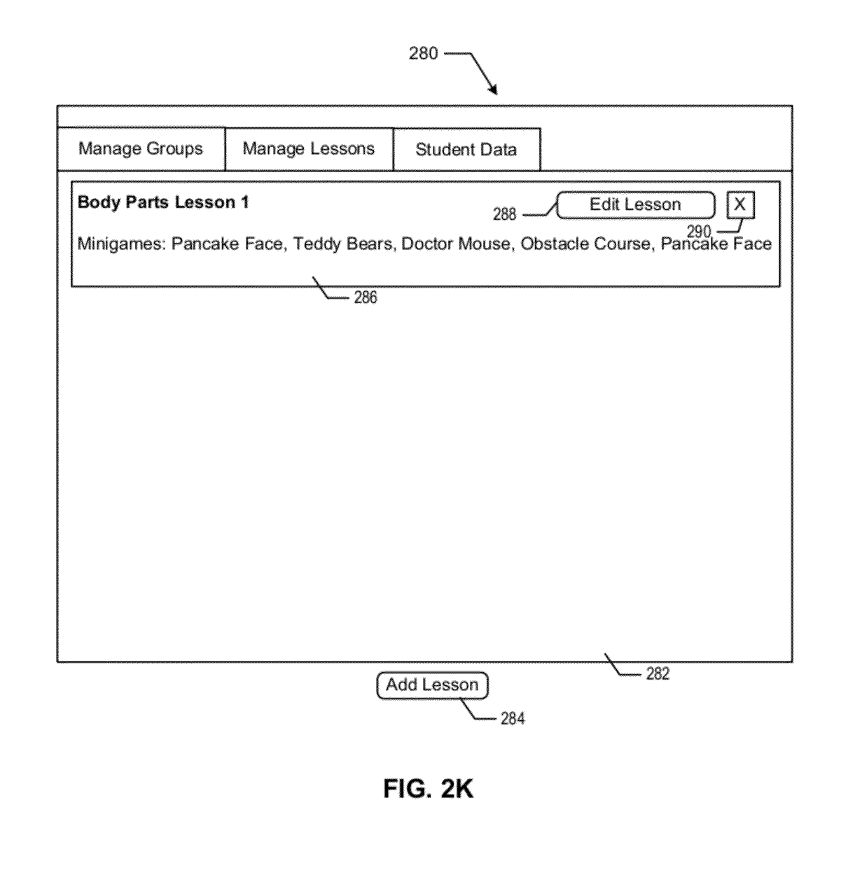

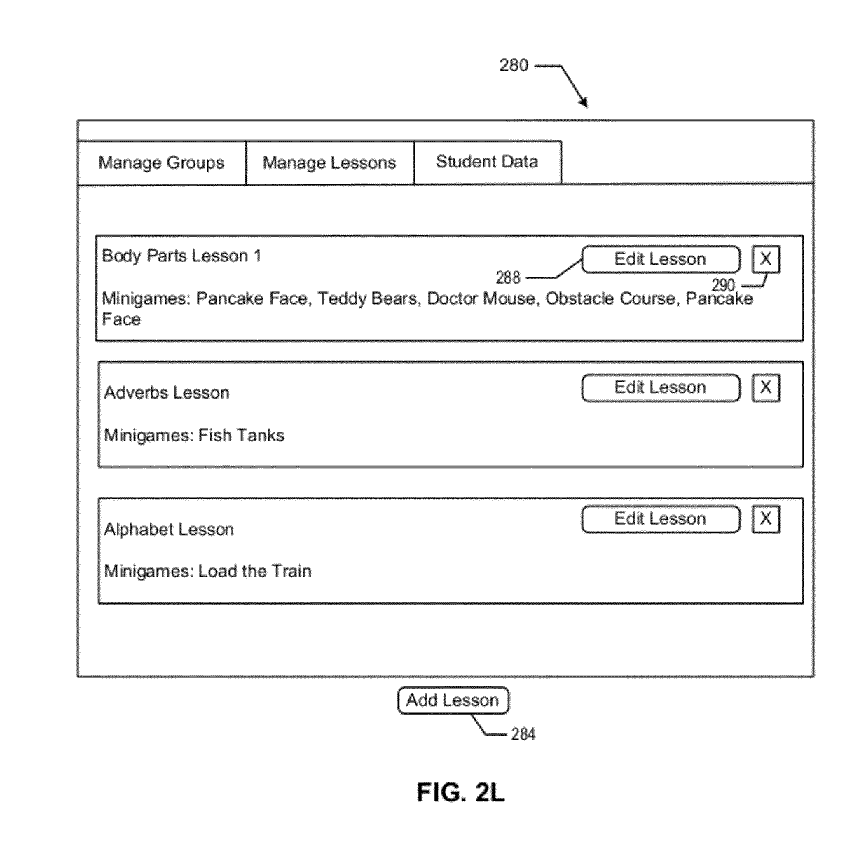

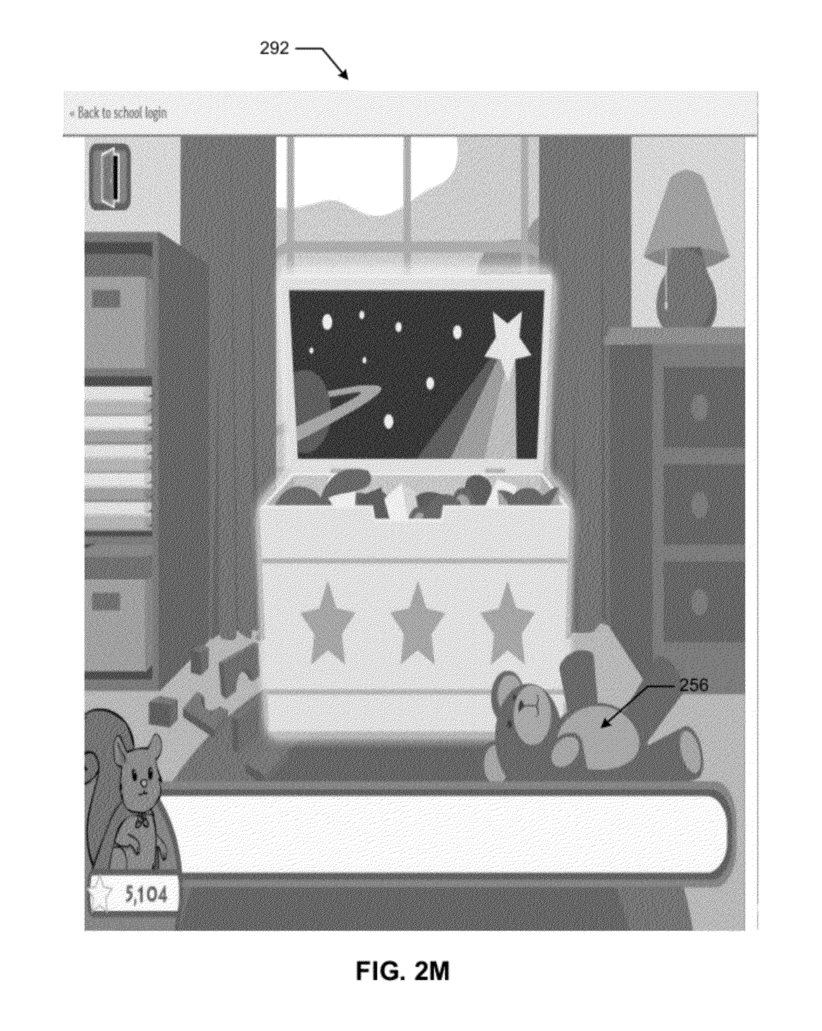

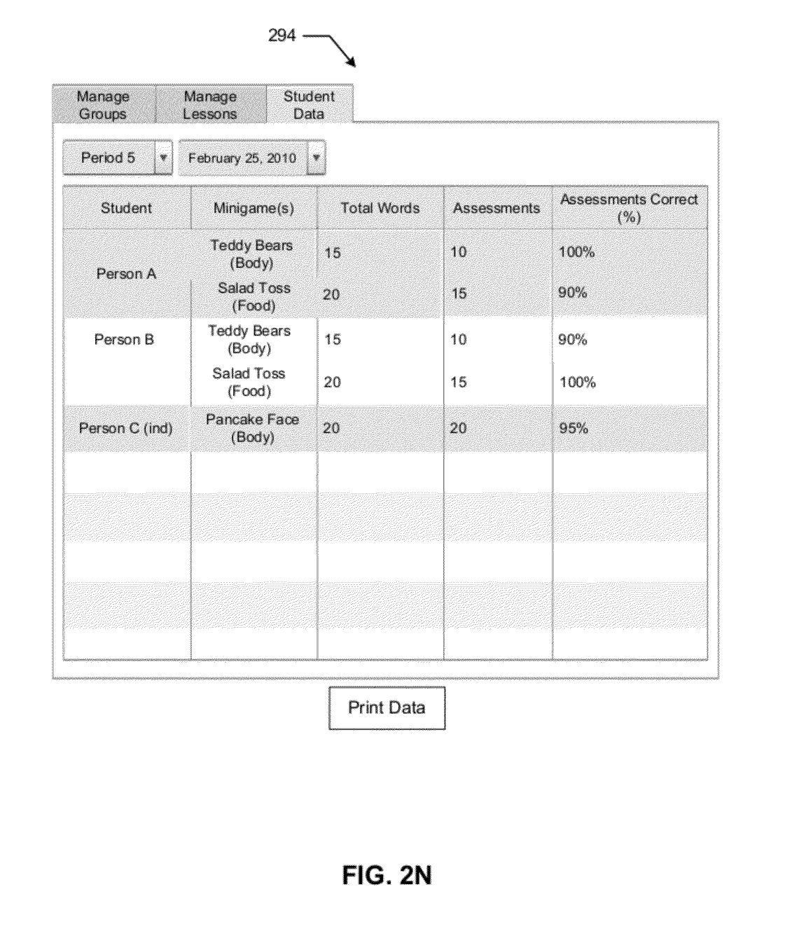

According to one aspect, before the user of the client 102A can retrieve the lesson plan data 118A or lesson plans 120A, 122A from the database 116A, the user of the client 102A interacts with the graphical user interface 114A to generate an authentication request 128A. The authentication request 128A is generated, for example, by a user interacting with the graphical user interface 114A to input user authentication data, such as a username and/or a password into an authentication or login form displayed on the screen. A screen shot of an exemplary authentication form 202 is depicted in FIG. 2A. The GUI application 112A transmits the authentication request 128A to the server 104A for authentication.

If the authentication request 128A is determined to correspond to an authorized user at the server 104A, the lesson planning tool 126A transmits a lesson plan management GUI to the client 102A for display. According to one aspect, the lesson plan management GUI includes one or more data entry forms. Each data form includes, for example, a data entry field and controls that enable the user to select options for a customized lesson plan. The user of the client 102A interacts with data entry forms via the graphical user interface 114A to generate a lesson plan creation request 130A. FIGS. 2B-2E are exemplary screen shots of various entry forms.

FIG. 2B depicts an exemplary lesson plan information form 204 that enables the user to enter information about a new customized lesson plan. In this example, the lesson plan information form 204 includes a Name field 206 and a Description field 208. The Name field 206 is, for example, a text field that allows the user to give a customized lesson a name. The Description field 208 is, for example, a text field that allows the user to give a brief description of the lesson. The exemplary lesson plan information form 204 includes a next control 209 that enables the user to view another management form when selected.

FIG. 2C depicts an exemplary audience lesson plan management form 210 that enables the user to define audience member data to include in a customized lesson plan. In this example, the audience lesson plan management form 210 includes a selection list box 212 and a selected list box 214. The selection list box 212 includes a list of names for students eligible to participate in lesson plans. The selected list box 214 includes a list of names for students currently selected to participate in a particular lesson plan.

According to one aspect, the user selectively adds names to the selected list box 214 by selecting (e.g., mouse click) one or more names in the selection list box 212 and then selecting an add control 216 displayed on the audience lesson plan management form 210. In addition, the user can selectively remove names from the selected list box 214 by selecting (e.g., mouse click) one or more names in the selected list box 214 and then selecting a remove control 218 displayed on the audience lesson plan management form 210. According to another aspect, the user can selectively add names to the selected list box 214 or remove names from the selected list box 214 through a “drag and drop” operation. The audience lesson plan management form 210 includes a next control 219 that enables the user to view another management form when selected.

In other aspect, lesson plans and groups can be created separately. For example, another audience lesson plan management form 210, such as depicted in FIG. 2D and FIG. 2E can be used to create a particular group of audience members. For example, a first group of audience members may correspond to students in a first period English Class and a second group may correspond to another group of students in same English Class, but during a second period. A third group may correspond to yet another group of students in a Math Class during the first period. After a group is created, a customized lesson plan can be applied to a particular group or removed from that particular group. In other words, lesson plans need not be intrinsically tied to groups.

In this example, the audience lesson plan management form 210 includes a selection list box 212, a selected list box 214, an add control 216, and remove control 218 that each operate substantially the same as the audience lesson plan management form 210 described above in reference to FIG. 2C. The exemplary audience lesson plan management form 210 also includes a group name field 220 that enables the user to enter a name for a particular group being created and a save control 222 that enables the user to save that particular named group of audience members in, for example, the database 116A. The exemplary audience lesson plan management form 210 further includes a cancel control 224 that enables the user cancel the creation of the group.

FIG. 2F depicts an exemplary game selection management form 226 that enables the user to select games to include in a lesson plan. The game selection management form 226 displays a list of available minigames 228 for various game sets or game categories, such as such as Food, Color, Furniture, Body, etc. In this example, the game set labeled Food includes available minigames 228 Dessert Machine, Fruit Artwork, Fruit Salad, Garden Planting, Grocery Sling Shot, Salad Toss, and Sandwich Helper. The game selection management form 226 also displays a check box control 280 adjacent to each of the available minigames 228. The user can select (e.g., a mouse click) one or more particular games by selecting a corresponding adjacent check box control 230. The game selection management form 226 includes a next control 232 that enables the user to view a subject data type selection form 234 when selected.

FIG. 2G depicts an exemplary subject data selection form 234 that enables the user to select the type of subject data that will be presented during the customized lesson plan. The subject data selection form 234 includes a selection list box 236 that includes a list of words not to include in the lesson plan. The subject data selection form 234 also includes a selected list box 238 that includes a list of words to include in the customized lesson plan. The user can selectively add subject data (e.g., words) to the selected list box 238 by selecting (e.g., mouse click) one or more lexical items in the selection list box 236 and then selecting an add control 240 displayed on the subject data selection form 234. In this example, the user has used the exemplary subject data selection form 234 to designate the words head, stomach, arms, legs, and ears for inclusion in the Teddy Bear minigame during the lesson. According to another aspect, the user can selectively add subject data to the selected list box 238 or remove subject data from the selected list box 238 through a “drag and drop” operation.

In addition, the user can selectively remove subject data from the selected list box 238 by selecting (e.g., mouse click) one or more minigames in the selected list box 238 and then selecting a remove control 242 displayed on the subject data selection form 234. The exemplary subject data selection form 234 includes a “use these words” control 244 that designates the subject data in the selected list box 238 to include in the lesson creation request 130A when selected. The exemplary subject data selection form 234 also includes a cancel control 246 that enables the user to return to the game selection management form 226.

FIG. 2H depicts an exemplary combination game/subject data selection form 248. The combination game/subject data selection form 248 enables the user to select game data to include in a particular customized lesson plan and enables the user to select the type of subject data that will be presented during that customized lesson plan. In this example, the combination game/subject data selection form 248 includes a minigame selection list box 250 and a minigame selected window 252. The minigame selection list box 250 displays game sets or game categories of available minigames 228, such as such as Adverbs, Alphabet, Furniture, Body, etc. The minigame selected window 252 displays the list of minigames that have been selected by the user to include in the particular customized lesson plan.

In this example, by selecting a particular game category in the minigame selection list box 250, the user can view one or more available minigames within that particular game category. For example, if the user selects the game category “Body”, a list of available minigames, such as Pancake Face, Teddy Bears, Doctor Mouse, and Obstacle Course are displayed in the list box 250. The user can selectively add one or more particular minigames to the minigame selected window 252 by selecting (e.g., a double mouse click) the name of the one or more particular minigames displayed in the list box 250. The one or more particular minigames 228 displayed in minigame selected window 252 correspond to the one or more particular minigames that will be played or presented during the customized lesson plan.

According to one aspect, the minigame selected window 252 displays each minigame selected in a corresponding minigame sub-window 254. Each minigame sub-window 254 enables the user to view the type of subject data (e.g., list of words) that will be presented during the corresponding minigame. Each minigame sub-window 254 includes an edit control 256 and a delete control 258. The edit control 256, for example, enables the user to edit the list of words to include in the corresponding minigame. The delete control 258 enables the user to delete the corresponding minigame from the particular customized lesson plan.

According to another aspect, the order in which each minigame sub-window 254 is displayed includes the order that corresponding minigame will be played during the customized lesson plan. The order in which each minigame sub-window 254 is displayed depends, for example, on the order in which the corresponding minigame was selected from the minigame selection list box 250. In this example, the minigame sub-window 254 that corresponds to the “Pancake Face” is displayed at the top because it was selected first and the minigame sub-window 254 that corresponds to the “Teddy Bears” is displayed second from the top because Teddy Bears was selected second. According to another aspect, the user can selectively rearrange the displayed order of the minigame sub-windows 254 through a “drag and drop” operation. For example, the user can use a drag and drop operation to move the minigame sub-window 254 that corresponds to the “Pancake Face” below the minigame sub-window 254 that corresponds to the “Teddy Bears.”

The exemplary combination game/subject data selection form 248 also includes a save control 256 that enables the user to save the customized lesson that includes the one or more particular minigames displayed in the minigame selected window 252. The exemplary combination game/subject data selection form 248 further includes a cancel control 224 that enables the user cancel the creation of the custom lesson plan.

FIG. 2I depicts an exemplary rules selection management form 260 that enables the user to enter rule data that will generate some or all of the set of minigames included in the lesson plan. In one example, the rules selection management form 260 displays a list of available rules 262.

The rules selection management form 260 also displays a check box control 264 adjacent to each of the available rules 262. The rules selection management form 260 also displays a dropdown control 266 that is also displayed adjacent to each of the available rules 262. When a corresponding check box control 264 is selected for a given rule, the corresponding dropdown control 266 will enable the user to designate a number of games that are presented to the user during the lesson plan according to that particular rule. For example, if the user selects a corresponding check box control 264 next to a “newest games” rule and then selects the number “3” in the corresponding dropdown control 266, a maximum of “3” games will be selected according to the “newest games” rule and presented during a lesson. The rules selection management form 260 includes an add control 268 that, when selected by the user, designates the selected rules and the selected maximum number of games as rule data to include in the lesson creation request 130A. The rules selection management form 260 includes a next control 270 that enables the user to view a lesson plan summary form 272 when selected.

FIG. 2J depicts an exemplary lesson plan summary form 272 that displays a summary field 274 that includes the total number of games included in the lesson plan and a range for average estimated play time. In this example, the user selected the Teddy Bears game from the Body game category or set and selected corresponding lexical items head, stomach, legs, arms, and ears. The user also selected the Salad Toss game from the Food game category or set and selected corresponding lexical items tomato, carrot, lettuce, and onion.

If the user is satisfied with the selected minigames, the selected subject data, and the one or more particular rules to include in the lesson plan, the lesson plan creation request 130A is generated by the user interacting with the a lesson plan summary form to select, for example, a save control 276. The exemplary lesson plan summary form 272 includes a back control 278 that enables the user to view a previously displayed form when selected.

In other aspect, a customized lesson plan edit form 280, such as depicted in FIG. 2K and FIG. 2L, enables a user to edit customized lesson plans. In this example, the customized lesson plan edit form 280 includes a lesson management window 282. The lesson management window 282 displays a list of customized lesson plans stored, for example, in a database. The lesson management window 282 includes an add lesson control 284 that enables a user to add lessons to new custom lesson plans.

According to one aspect, the lesson management window 282 displays a name of each customized lesson in a corresponding customized lesson sub-window 286. Each customized lesson sub-window 286 enables the user to view the minigames that will be presented or played during the corresponding customized lesson plan. Each customized lesson sub-window 286 includes an edit control 288 and a delete control 290. The edit control 288, for example, enables the user to edit the list of minigames to include in the corresponding lesson plan and to generate a lesson plan modification request. The delete control 290 enables the user to delete the corresponding customized lesson plan.

Referring back to FIG. 1A, according to one aspect, the lesson planning tool 126A receives the lesson plan creation request 130A from the client 102A via the data communication network 106A. The lesson plan creation request 130A includes, for example, selected game data (e.g., minigames), selected subject data, (e.g., selected words), selected rule data (e.g., selected rules and selected maximum number of games), and audience data (e.g., names of audience members assigned to the lesson plan). As explained in more detail below, the lesson planning tool 126A creates a customized lesson plan for one or more audience members based on the audience member data, selected games data, selected subject data, and/or the selected rule data included in the received lesson plan creation request 130A. The lesson planning tool 126A then creates a customized lesson plan record 124A for storage in the database 116A. As described above, the customized lesson plan record 124A identifies the created customized lesson plan and associated audience members.

According to another aspect, another authenticated user, such as a particular audience member, interacts with the lesson plan request form (not shown) via the graphical user interface 114A to enter lesson plan retrieval data to generate a lesson plan request 132A. For example, the authenticated audience member is, for example, a student user that interacts with the lesson plan request form via the graphical user interface 114A to enter retrieval data, such as his or her name. In other aspects, the student user interacts with the lesson plan request form via the graphical user interface 114A to enter other retrieval data, such as name of the particular customized lesson plan, an area of study (e.g., Spanish), instructor name, or other identifying information. The lesson plan request form also includes a retrieve lesson plan control (not shown) that when selected generates the lesson plan request 132A. The generated lesson plan request 132A includes lesson plan retrieval data.

The lesson planning tool 126A receives the lesson plan request 132A from the client 102A via the data communication network 106A. The lesson planning tool 126A then retrieves a particular customized lesson plan from the databases 116A based on lesson plan retrieval data included in the lesson plan request 132A. The lesson planning tool 126A transmits the particular customized lesson plan to the client 102A for presentation to the requesting audience member.

The content included in a particular customized lesson plan may include text, images, information graphics, and/or animated video, such as cartoons. For example, the customized lesson plan may begin by displaying an introduction page 292, such as a club house page depicted in FIG. 2M. The clubhouse may include a toy box which an image corresponding to the next required minigame appears out of. Upon selecting the image corresponding to the minigame, the minigame may begin.

According to another aspect, the lesson planning tool 126A generates a report that indicates the user's performance during the lesson plan. For example, during the lesson plan the user may be required to identify Spanish language words that correspond to English language words. The generated report indicates an accuracy level or performance level of a particular user and/or a group of users. FIG. 2N depicts an exemplary screen shot of a report 294 generated by the lesson planning tool 126A.

An administrative user interface (UI) 134A may be coupled to the server 104A such that an administrator, or administrative user, of the server 104A may interact with the administrative UI 134A to generate lesson plan creation/update request 136A. As an example, the lesson plan creation/update request 136A is generated by the administrative user interacting with an administrative input form (not shown) to define lesson data, lessons, and/or audience profile data to add to the database 116A. The administrative UI 134A may include a display 138A, such as a computer monitor, for viewing media presentation data and/or audience profile data and/or input forms, and an input device 140A, such as a keyboard or a pointing device (e.g., a mouse, trackball, pen, or touch pad), for entering media presentation data and/or for entering audience profile data for a particular audience member into the administrative input form.

According to one aspect, the lesson planning tool 126A receives a lesson plan modification request 142A from the client 102A via the data communication network 106A. According to one aspect, the user interacts with a lesson plan edit form, such as described in references FIGS. 2K and 2L, to generate the lesson plan modification request 142A. The lesson plan modification request 142A includes, for example, modified game data (e.g., minigames), modified subject data, (e.g., selected words), modified rule data, and/or modified audience data.

Although FIG. 1A illustrates a client 102A communicating with the server 104A that is configured with the lesson planning tool 126A, in other aspects it is contemplated that the lesson plan system 100 can be implemented on a single computing device. For example, as shown in FIG. 1B, the computing device 102B can be configured with the lesson planning tool 126B and the data database 116B. As a result, users only interact with graphical user interface 114B on the display 108B and the input device 110B to retrieve lesson plan data 118 and lesson plans 120, 122 from the database 116B and to create custom lessons plan and custom lessons plan records 124B or storage in the database 116B.

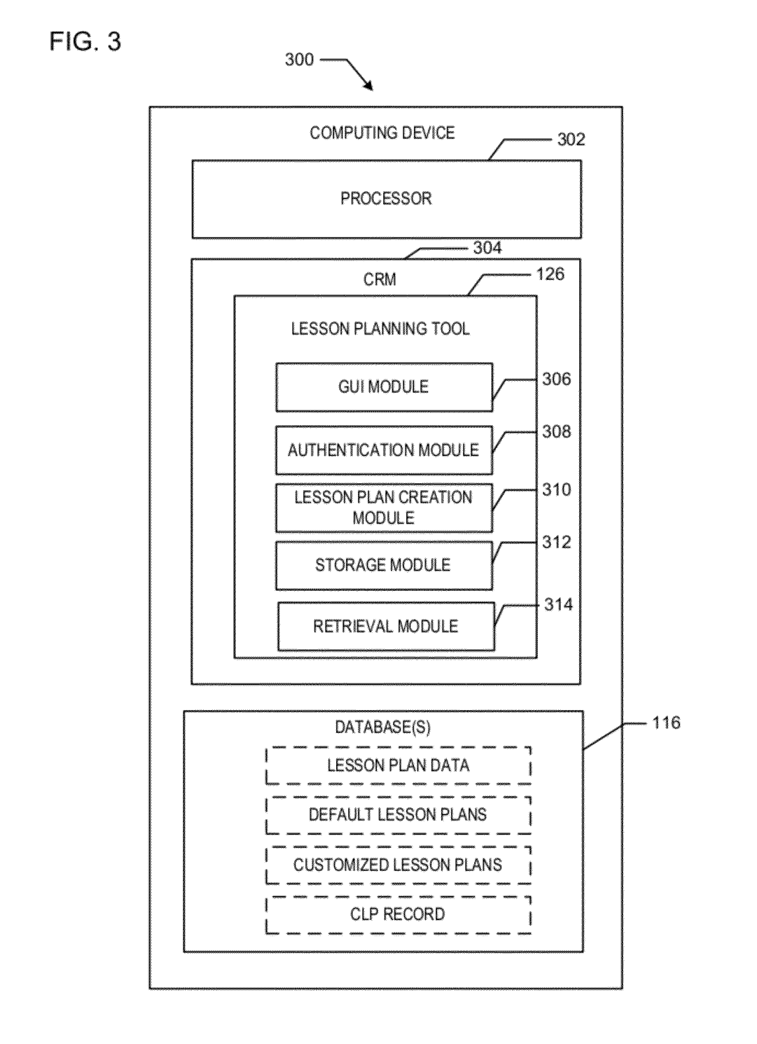

FIG. 3 is a block diagram that depicts an exemplary lesson planning tool 126 (e.g. 126A or 126B) executing on a computing device 300 (e.g., server 104A or client 102B). According to one aspect, the computing device 300 includes a processing system 302 that includes one or more processors or other processing devices. The processing system 302 executes the lesson planning tool 126 to retrieve lesson plan data and/or lesson plans from the database 116 for transmission to the client 102A. Although lesson planning tool can be implemented on server 104A or client 102B, for purposes of illustration, the computing device 300 is described below in reference to FIG. 1A.

According to one aspect, the computing device 300 includes a computer readable medium (“CRM”) 304 configured with the lesson planning tool 126A. The lesson planning tool 126 includes instructions or modules that are executable by the processing system 302 to retrieve lesson plan data and/or lesson plans from the database 116A for transmission to the client and/or to store a custom lesson plan in the database 116A in response to a received lesson plan creation request 130A.

The CRM 304 may include volatile media, nonvolatile media, removable media, non-removable media, and/or another available medium that can be accessed by the computing device 300. By way of example and not limitation, computer readable medium 304 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

A GUI module 306 transmits an authentication form to the client 102B after the client accesses the location of a lesson plan tool 126A of the lesson plan system by, for example, entering a uniform resource locator (URL) via the client 102A. As described above, the user of the client 102A interacts with the graphical user interface 114A to generate an authentication request 128A.

An authentication module 308 receives the authentication request 128A from, for example, the client 102A and determines if the request 128A is valid. For example, the authentication module 306 compares authentication data included in the authentication request 128A, such as such as a username and/or a password, entered by the user via the graphical user interface 114A to authentication data stored in the database. If the received authentication data matches authentication data stored in the database 116A, the GUI module 306 transmits a lesson plan management GUI that includes various data entry forms (e.g., see forms 204, 210, 226, 234, 248, 260, 280, 294) to the client 102A for display via the graphical user interface 114A. As described above, the user of the client 102A interacts with the various data entry forms graphical user interface 114A to select lesson plan data and generate the lesson plan creation request 130A. If the received authentication data does not match authentication data stored in the database 116A, the authentication module 308 transmits an invalid authentication data message to the client 102A for display via the graphical user interface 114.

A lesson plan creation module 310 receives the lesson plan creation request 130A from the client 102A and creates a customized lesson plan. As described above, the lesson plan request 130A includes lesson plan data, such as audience member data, game data, subject data, and/or rule data. According to one aspect, the lesson plan creation module 310 creates the customized lesson plan based on the selected game data and selected subject data. For example, the created lesson plan includes the selected games and each selected game uses the selected subject data during presentation of the game.

According to another aspect, the lesson plan creation module 310 creates the customized lesson plan based on the selected game data, the selected subject data, and the selected rules data. In this case, the lesson plan creation module 310 creates a custom lesson plan that will present the selected games according to the selected rules. For example, if the custom lesson plan includes five different minigames, but the rule data specifies a maximum of three of the newest minigames, only the newest games will be shown during presentation of the lesson.

The lesson plan creation module 310 also creates a customized lesson plan record 124A that includes one or more games identified by the game data, one or more words identified by the subject data, and corresponding rules and rule parameters identified by the rules data, if any. The customized lesson plan record 124A also includes one or more audience members identified by the audience data.

A storage module 312 stores the customized lesson plan and the customized lesson plan record 124A in the database in response to a storage request. The storage request is generated, for example, in response to a user selecting a save control or other control displayed on a data input form that indicates the user would like to store a defined customized lesson plan.

The storage module 312 can also store updated lesson plan data in response to input received at the graphical user interface. For example, an authorized user interacts with a lesson plan edit form (e.g., 280) via the graphical user interface 114A to select a particular customized lesson plan to modify and generate the lesson plan modification request 142A.

A retrieval module 314 retrieves a particular lesson plan stored in the database 116A in response to the lesson plan request 132A generated at the client 102A. In one aspect, as described above, the lesson plan request 132A is generated in response to the user interacting with the graphical user interface 114A to enter audience member data for a particular audience member into lesson plan request form. For example, the user can interact with the lesson plan request form to search for and/or select a particular audience member by name. After the user enters lesson plan retrieval data (e.g., audience member name) to identify the particular audience member, the retrieval module 314 queries the database 116A to identify a custom lesson plan record 124A associated with the particular audience member. The retrieval module 314 then transmits the identified customized lesson plan to the client for presentation to the requesting audience member.

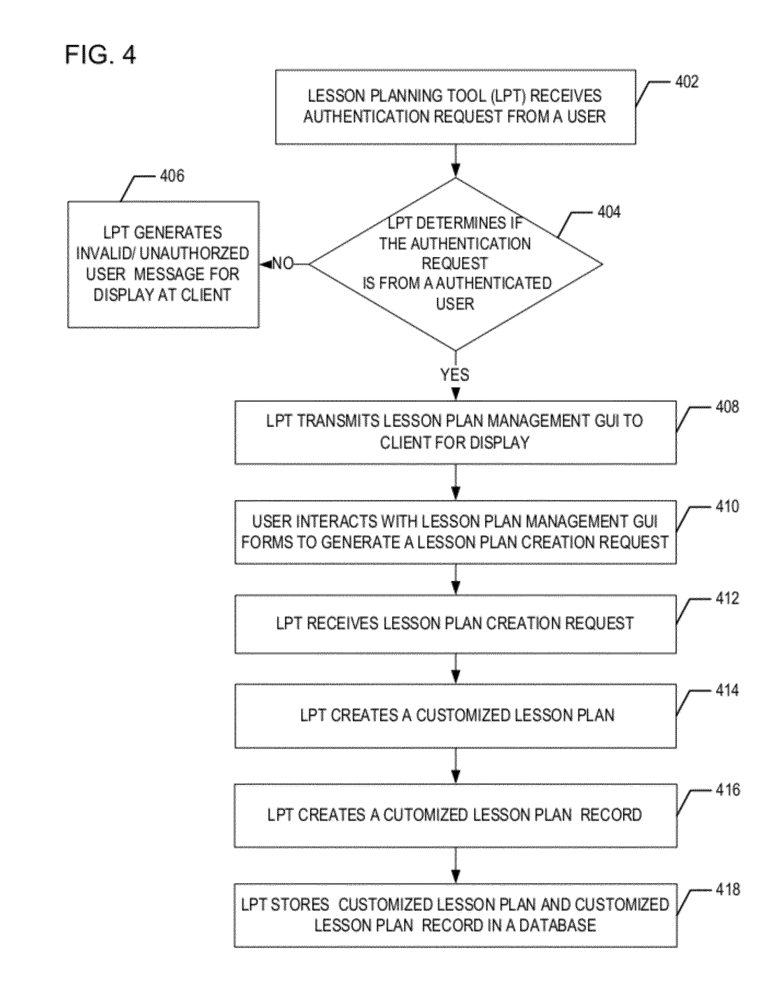

FIG. 4 illustrates a method for creating a lesson plan in accordance with an aspect of the lesson planning tool 126 (e.g., 102A). At 402, the lesson planning tool 126A receives an authentication request 128 from a client computer 102A. As described above, the authentication request 128A includes authentication data entered by a user into the authentication form 202 via the graphical user interface 114A. The lesson planning tool 126A determines if the authentication data entered by the user corresponds to valid authentication data at 404. If the authentication data is determined invalid at 404, lesson planning tool 126A transmits a message to the client 102A that indicates the authentication at 406. If the authentication data is determined valid at 404, the lesson planning tool 126A transmits a lesson plan management GUI to the client 102A for display at 408. As described above, the lesson plan management GUI includes one or more data entry forms.

At 410, the user interacts with the one or more forms at the client 102A to enter audience data, game data, and rule data and generate the lesson plan creation request 130A. The lesson planning tool 126A receives the lesson plan creation request 130A from a client computer 102A at 412. At 414, the lesson planning tool 126A creates a customized lesson plan that includes one or more games identified by the game data, one or more words identified by the subject data, and one or more rules identified by the rules data. The lesson planning tool 126A also creates a customized lesson plan record 124A that identifies customized lesson plan and identifies one or more audience members that are eligible to access the customized lesson plan at 416. At 418, the lesson planning tool 126A stores the customized lesson plan and the customized lesson plan record in the database 116.A

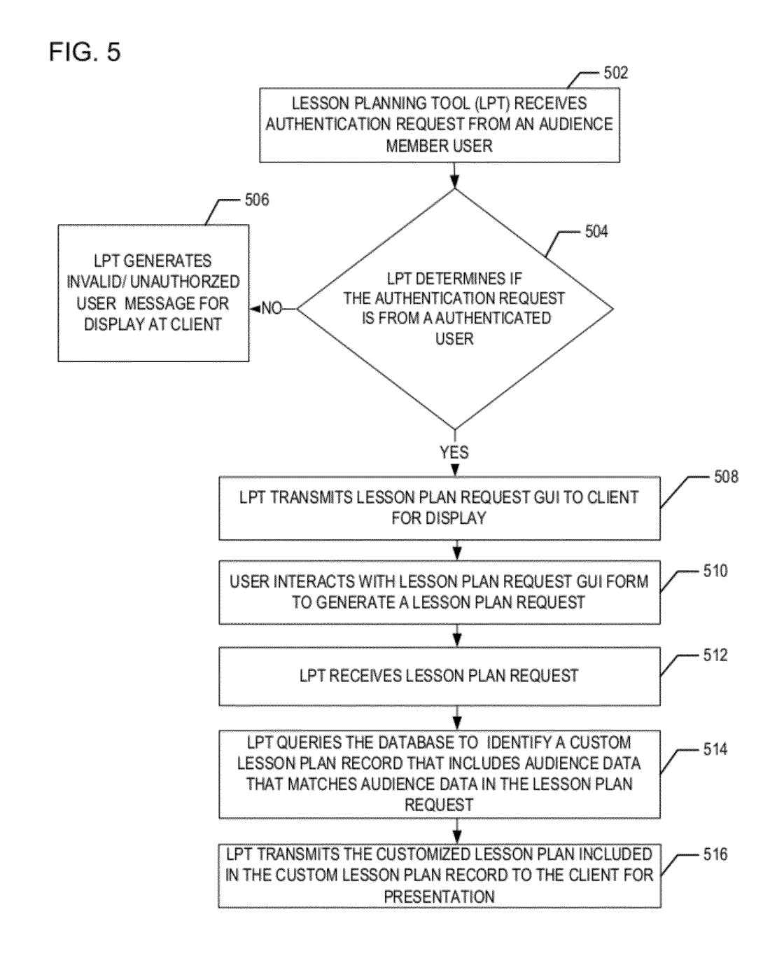

FIG. 5 illustrates a method for viewing a lesson plan in accordance with an aspect of the lesson planning tool 126A. At 502, the lesson planning tool 126A receives a different authentication request (not shown) from an audience member (e.g., student) via the client computer 102A. The lesson planning tool 126A determines if the authentication data entered by the user corresponds to valid authentication data at 504. If the authentication data is determined invalid at 404, lesson planning tool 126A transmits a message to the client 102A that indicates the authentication at 506. If the authentication data is determined valid at 504, the lesson planning tool 126A transmits a lesson plan request GUI to the client 102A for display at 508. The lesson plan management GUI displays, for example, a lesson plan request form.

At 510, the user interacts with the lesson plan request form at the client 102A to enter audience data and generate the lesson plan request 132A. The lesson planning tool 126A receives the lesson plan creation request 132A from a client computer 102A at 512. At 514, the lesson planning tool 126A queries the database 116A to identify a custom lesson plan record that includes audience data that matches audience data in the lesson plan request. The lesson planning tool 126A transmits the customized lesson plan included in the customized lesson plan record to the client 102A at 516.

Those skilled in the art will appreciate that variations from the specific embodiments disclosed above are contemplated by the invention. The invention should not be restricted to the above embodiments, but should be measured by the following claims.

What is claimed is:

1. A system for creating a lesson comprising:
at least one database; and
at least one processor encoded with a plurality of instructions, the at least one processor executing the plurality of instructions to:
generate at least one data entry form comprising lesson plan data for display, the lesson plan data comprising game data, educational subject data; lesson rule data, and audience member data;
receive a lesson plan creation request, the lesson plan creation request comprising a selection of at least two of an educational game from the game data, an educational subject, and a lesson rule;
create a custom lesson plan based on the selection of the at least two of the educational game from the game data, the educational subject, and the lesson rule; and
store the custom lesson plan in the at least one database.

2. The system of claim 1 wherein the plurality of instructions executed by the at least one processor are further configured to generate at least one reporting form for display, wherein the at least one reporting form enables a user to view a total number of games included in the lesson plan and an average estimated play time for each game.

3. The system of claim 1 wherein the at least one data entry form enables a user to select the at least two of the educational game, the educational subject, and the lesson rule to generate the lesson plan creation request.

4. The system of claim 1 wherein the plurality of instructions executed by the at least one processor are further configured to:
receive a lesson plan request, the lesson plan request identifying a particular custom lesson plan;
retrieve the particular custom lesson plan from the database; and
transmit the particular custom lesson plan for display.

5. The system of claim 4 wherein the plurality of instructions executed by the at least one processor are further configured to generate at least one other reporting form for display, wherein the at least one reporting form enables a user to view one or more performance parameters of the user's performance during the particular custom lesson plan.

6. The system of claim 4 wherein the plurality of instructions executed by the at least one processor are further configured to:
receive a lesson plan modification request, the lesson plan modification request:
identifying the particular custom lesson plan to modify; and
comprising modified lesson data;
modify the particular custom lesson plan based on the modified lesson data to create a modified custom lesson plan; and
replace the lesson plan stored in the database with the modified lesson plan.

7. The system of claim 6 wherein the plurality of instructions executed by the at least one processor are further configured to:
generate at least one other data entry form for display, wherein the at least one other data entry form enables a user to enter the particular custom lesson plan and the modified lesson data to generate the lesson plan modification request.

8. The system of claim 1 wherein the audience member data comprises a name, contact information, and authentication information for each of one or more audience members assigned to each custom lesson plan stored in the database.

9. The system of claim 1 wherein the lesson rule associated with a stored custom lesson plan comprises at least one rule for selecting one or more minigames to display during execution of that custom lesson plan.

10. The system of claim 9 wherein the at least one rule comprises” a highest word accuracy rule to present minigames with a highest word accuracy;
a lowest word accuracy rule to present minigames with a lowest word accuracy;
a newest rule game to present newest minigames;
an infrequent played rule to present most infrequently played minigames
a frequently played rule to present most frequently played minigames; and
a random presentation rule to present random minigames.

11. A system for creating a lesson comprising:
at least one database; and
at least one processor encoded with a plurality of instructions, the at least one processor executing the plurality of instructions to:
generate at least one data entry form comprising lesson plan data for display, the lesson plan data comprising game data, educational subject data; lesson rule data, and audience member data;
receive a lesson plan creation request, the lesson plan creation request comprising a selection of at least two of an educational game from the game data, an educational subject, and a lesson rule;
create a custom lesson plan based on the selection of the at least two of the educational game from the game data, the educational subject, and the lesson rule;
store the custom lesson plan in the at least one database;
receive a lesson plan request, the lesson plan request identifying a particular custom lesson plan;
retrieve the particular custom lesson plan from the database; and
transmit the particular custom lesson plan for display.

12. The system of claim 11 wherein the plurality of instructions executed by the at least one processor are further configured to generate at least one other reporting form for display, wherein the at least one reporting form enables a user to view one or more performance parameters of the user's performance during the particular custom lesson plan.

13. The system of claim 11 wherein the plurality of instructions executed by the at least one processor are further configured to:
receive a lesson plan modification request, the lesson plan modification request:
identifying the particular custom lesson plan to modify; and
comprising modified lesson data;
modify the particular custom lesson plan based on the modified lesson data to create a modified custom lesson plan; and
replace the lesson plan stored in the database with the modified lesson plan.

14. The system of claim 13 wherein the plurality of instructions executed by the at least one processor are further configured to:
generate at least one other data entry form for display, wherein the at least one other data entry form enables a user to enter the particular custom lesson plan and the modified lesson data to generate the lesson plan modification request.

15. A method for creating a lesson comprising:
generating at least one data entry form comprising lesson plan data for display, the lesson plan data comprising game data, educational subject data; lesson rule data, and audience member data;
receiving a lesson plan creation request at a processor, the lesson plan creation request comprising a selection of at least two of an educational game from the game data, an educational subject, and a lesson rule;
creating a custom lesson plan at the processor based on the selection of the at least two of the educational game from the game data, the educational subject, and the lesson rule; and
storing the custom lesson plan in at least one database.

16. The method of claim 15 further comprising generating at least one reporting form for display, wherein the at least one reporting form enables a user to view a total number of games included in the lesson plan and an average estimated play time for each game.

17. The method of claim 15 wherein the at least one data entry form enables a user to select the at least two of the educational game, the educational subject, and the lesson rule to generate the lesson plan creation request.

18. The method of claim 15 further comprising:
receiving a lesson plan request at the processor, the lesson plan request identifying a particular custom lesson plan;
retrieving the particular custom lesson plan from the database; and
transmitting the particular custom lesson plan for display.

19. The method of claim 18 further comprising generating at least one other reporting form for display, wherein the at least one reporting form enables a user to view one or more performance parameters of the user's performance during the particular custom lesson plan.

20. The method of claim 18 further comprising:
receiving a lesson plan modification request at the processor, the lesson plan modification request:
identifying the particular custom lesson plan to modify; and
comprising modified lesson data;
modifying the particular custom lesson plan at the processor based on the modified lesson data to create a modified custom lesson plan; and
replacing the lesson plan stored in the database with the modified lesson plan.

21. The method of claim 20 further comprising generating at least one other data entry form for display, wherein the at least one other data entry form enables a user to enter the particular custom lesson plan and the modified lesson data to generate the lesson plan modification request.

22. The method of claim 18 wherein the lesson rule associated with a stored custom lesson plan comprises at least one rule for selecting one or more minigames to display during execution of that custom lesson plan.
